(19) United States
(12) Patent Application Publication
(10) Pub. No.: US 2026/0086868 A1
(43) Pub. Date: Mar. 26, 2026

(54) MAINTENANCE MANAGEMENT OF INFRASTRUCTURE HOSTS FOR A DATABASE CLOUD ENVIRONMENT

(71) Applicant: Oracle International Corporation, Redwood Shores, CA (US)

(72) Inventors: Nagarajan Muthukrishnan, San Ramon, CA (US); Prasanna Ramamurthi, Bangalore (IN); Niloy Banerjee, Cupertino, CA (US); Binoy Sukumaran, Foster City, CA (US); Srikanth Nagandla, Fremont, CA (US)

(73) Assignee: Oracle International Corporation, Redwood Shores, CA (US)

(21) Appl. No.: 18/898,501

(22) Filed: Sep. 26, 2024

(51) Int. Cl. G06F 9/50; G06F 8/65

(52) U.S. Cl. CPC G06F 9/5038; G06F 8/65; G06F 9/5072; G06F 9/5088; G06F 2209/5011; G06F 2209/5021; G06F 2209/505

(57) ABSTRACT

Disclosed is an improved approach to implement more efficient upgrades and patches of nodes in a multi-tenant environment. Described in an improved approach to handle VM cluster maintenance through maintenance domains which partitions the interval and pool of hardware nodes, and where subsequent operations handling these concepts provide the required maintenance schedules satisfying any customer requirements.

### BACKGROUND

In a cloud computing environment, computing systems may be provided as a service to customers. One of the main reasons for the rising popularity of cloud computing is that the cloud computing model typically allows customers to avoid or minimize both the upfront costs and ongoing costs that are associated with maintenance of IT infrastructures. Moreover, the cloud computing paradigm permits high levels of flexibility for the customer with regards to its usage and consumption requirements for computing resources, since the customer only pays for the resources that it actually needs rather than investing in a massive data center infrastructure that may or may not be efficiently utilized at any given period of time.

The cloud resources may be used for any type of purpose or applicable usage configuration by a customer. For example, the cloud provider might host a large number of virtualized processing entities (such as “virtual machines” or “VMs”) on behalf of the customer in the cloud infrastructure. The cloud provider may provide devices from within its own infrastructure location that are utilized by the cloud customers. In addition, the cloud provider may provide various services (e.g., database services) to customers from the cloud. As yet another example, the cloud provider may provide the underlying hardware device to the customer (e.g., where the device is located within the customer's own data center), but handle implementation and administration of the device as part of the cloud provider's cloud environment.

One of the main functions performed by the cloud provider in the cloud computing model is the administration and maintenance of the cloud computing resources. By having the administrative staff of the cloud provider take control over these administrative tasks, this minimizes the need and costs for the customer to maintain its own IT staffing and infrastructure to handle these tasks, which is in essence one of the main advantages of the cloud computing paradigm for customers.

A common task for an administrator is the need to patch/upgrade the hosts/nodes within the resources in the cloud infrastructure. A patch or upgrade (hereinafter collectively referred to as patch) may include a one-off fix for specific problems, or a periodic version update. Regardless of why the patch needs to be installed, the administrator must generally perform a complex series of steps on each node in order to rollout the patch while minimizing application downtime, including ensuring the patching environment is up to date on each host; shutting down those servers running on the host; and then patching and restarting the application server instances and verifying the patch works correctly. Since patching is a complex process, and even for a single application server instance can take a significant amount of time, which can become even longer when applied to all nodes in a given set of nodes, the process can create anxiety for users who risk the possibility of system downtime.

These actions to perform a patch is onerous even when a given node to process includes only virtualized entities from a single tenant. However, if the node includes numerous virtualized entities from numerous different tenants, then the need to coordinate the upgrade process among the various tenants for that node becomes a very problematic situation, as it is likely that each tenant has its own requirements of timing in order to minimize disruptions to the tenant's workloads.

Therefore, there is a need for an improved approach to perform software installations, patches, and upgrades that address the issues identified above.

### SUMMARY

The present invention provides an improved approach to perform more efficient upgrades and patches of nodes in a multi-tenant environment. According to some embodiments, described in an improved approach to handle cluster maintenance through maintenance domains which partitions the interval and pool of hardware nodes, and where subsequent operations handling these concepts provide the required maintenance schedules. As described, this approach is well suited in the context of VM cluster maintenance and can satisfy any required availably requirements for the multi-tenant customers

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 shows a flowchart of an approach to implement some embodiments of the invention.

FIG. 2 provides an illustrative example of nodes that are organized into maintenance domains.

FIG. 3 shows a flowchart of an approach to use maintenance domains to implement patching/upgrades according to some embodiments.

FIG. 4 shows a more detailed flowchart of actions that are performed according to some embodiments of the invention.

FIGS. 5A-M provide an illustrative example of the actions shown in FIG. 4.

FIG. 6 is a block diagram of an illustrative computing system suitable for implementing an embodiment of the present invention.

FIG. 7 is a block diagram of one or more components of a system environment in which services may be offered as cloud services, in accordance with an embodiment of the present invention.

### DETAILED DESCRIPTION OF THE EMBODIMENTS OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

Enterprise class applications (such as the RDBMS database products provided by Oracle Corporation) support clustered execution across independent environments for providing high availability and scalability. In a heterogeneous cloud infrastructure (such as Oracle Corporation's Autonomous Cloud product), these clustered databases from various tenants can be consolidated in their own virtual machine clusters. However, the consolidation process may result in VMs from different tenants that are packed onto the same physical hosts.

To provide stable and secure environment, these physical hosts need to be periodically maintained by applying critical software and hardware patches. As part of this process, to avoid interference in the customer VMs and their databases, these VMs will be migrated to another host at a higher-level patch. This should be performed while sustaining the required availability for customer VMs among their VM clusters, providing additional capacity of physical hosts, and proper planning in allowing customers to have a suitable migration schedule and intelligent management of hosts to avoid increased additional capacity. Additionally, these maintenance activities should be completed in a periodic manner.

Even though individual VM migration through various technologies is a solved problem, managing the maintenance of hosts involving VM clusters and at the same time maintaining the customer expectation in terms of availability and reduced interruption in services is a complex challenge.

Embodiments of the present invention provides an improved mechanism to implement such upgrades/patches, in an efficient, scalable, and performant way. According to some embodiments, the invention uses the concept of “maintenance domains” to properly schedule hosts for maintenance, to manage the VMs in physical hosts through distinct domains, and to satisfy other and additional expectations and requirements.

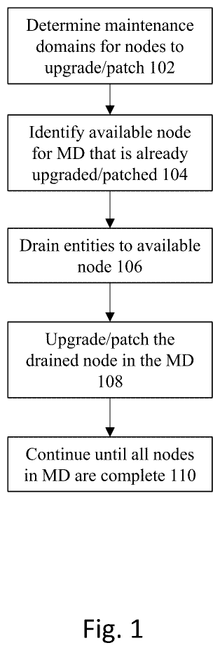

FIG. 1 shows a flowchart of an approach to implement some embodiments of the invention. At 102, maintenance domains (MDs) are logically defined over the set of nodes that are to be patched/upgraded. Each node within a given maintenance domain is considered to have the same state during the upgrade flow, and thus can be considered to be at the same stage of preparedness for upgrading that node. This permits the nodes to be grouped into maintenance domains such that clients/customers that have VMs on those nodes can be organized and coordinated to efficiently perform and process the patch/upgrades for those nodes in that maintenance domain.

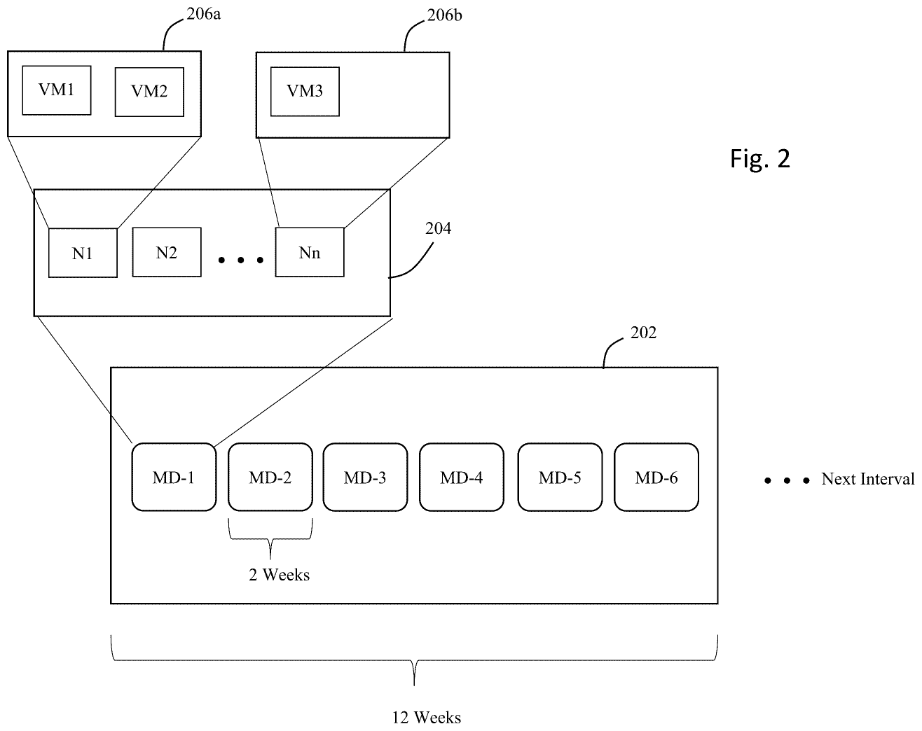

FIG. 2 provides an illustrative example of nodes that are organized into maintenance domains. Each maintenance domain 204 (such as MD-1, MD-2, . . . MD-n) corresponds to a set of grouped nodes (N1, N2, . . . Nn), where each node may include zero or more virtualized entities running on those nodes. As used herein a non-overlapping interval and the logical grouping of nodes can be referred to as “Maintenance Domain” or “MD”. The maintenance domain is essentially a split of maintenance duration into non-overlapping intervals and logical separate of compute nodes among them.

A set 202 of maintenance domains are logically associated with each other within a given interval period. The intervals provide a time frame in which the maintenance domains within that interval are processed. As shown in this figure, each interval may correspond to a time frame of 12 weeks. Therefore, all nodes within the maintenance domains in this time frame will be processed for an upgrade or patch within the same 12 week time period. Each subsequent time interval provides its own multi-week time period for processing the nodes in the maintenance domains for that subsequent time period. This approach therefore provides a known time frame that users can therefore recognize and consider as they plan their workload placement with respect to upcoming maintenance activities that will need to occur.

Within a time interval for a set of maintenance domains, each maintenance domain may undergo its scheduled and/or staggered cycle of patching/upgrades. For example, succeeding 2 week periods may be defined to process each maintenance domain in order, where that time period will allow the customer to receive notice of the upcoming maintenance activities, and to manage its workload ahead of time to address the possible restart/shutdown of a node that currently holds its VM(s).

Within a given node 206a or 206b, the nodes may include any number of VM(s) for any number of different tenants. It is possible that the number of VMs and/or the workload currently on a given node is not uniform across all the nodes. As shown in this figure, node N1 206a currently comprises two virtual machines VM1 and VM2. In contrast, node Nn only comprises a single virtual machine VM3. This may have occurred, for example, if various workload levels have recently changed on the nodes such that the loads across the nodes are no longer balanced. The upgrade process itself according to an embodiment of the invention may also serve to allow more efficient allocation of VMs to nodes, e.g., where the replacement nodes for an MD are “filled up” and/or load balanced to more efficiently distribute VMs during the upgrade process.

With embodiments of the invention, the processing of patches/upgrades is performed on an MD-basis. The nodes within an MD are processed together, and each node processed in a way where its scheduled and coordinated movement of its virtualized entities are handled together to another node.

Returning back to FIG. 1, at 104, an identification is made of the MD that is currently to be processed. For a node within the MD that needs to be processed, another available node is identified that can be used to hold the VMs on that MD's node. The manner in which the alternate node is from a free pool is described in more detail below.

Thereafter, at 106, the VMs are drained from the MD's node and restarted onto the alternate node. At this point, once all VMs have been drained from the MD's node, then at 108, that node can then undergo its upgrade/pathing processing. This continues at 110 until all nodes in the MD has been processed. These steps are then repeated until all MDs in a given time interval have been processed.

One reason to organize nodes into maintenance domains is because not all of the nodes can be imaged together. This is because, for example, the notification for all the VMs cannot be sent on the same time frame to give enough time to allow the customers to migrate their VMs, since doing all at the same time would require 100% reservation of the VMs. As such, nodes in fabrics should be properly grouped and imaged. Different groups should be non-overlapping within the maintenance period.

Any number of maintenance domains may be defined. With respect to capacity reservation as a theoretical matter, the system just needs one additional group to the overall maintenance planning. Hence based on the number of MDs, the reservation requirements can vary. In some embodiments, a decision of the number of maintenance domains is an important aspect part of the system, and is a configurable model that allows the system to consider between capacity reservation versus internal fragmentation.

For example, consider a maintenance period of 90 days. Dividing this period into 3 MDs will result in less fragmentation but requires 33% reservation. At the same time, dividing this into 6 MDs will result in more fragmentation but only requires approximately 16% reservation. Physical hosts having VMs are assigned a corresponding MD. Hence the MD is a combination of physical hosts and the distinct interval. If there are ‘n’ MDs, the physical hosts can be roughly grouped into n+1 partitions, with one additional partition for roll over.

All the VMs in the hosts within current MD will be migrated to a patched set of hosts within this MD period. Once the VMs are vacated, the current hosts will be patched and used for the next MD rollover. Note that the VMs in the current MD will be patched exactly in the same period in the next maintenance period. In some embodiments, customers get a choice of migrating their VMs anytime within the MD duration (e.g., during a notification period).

The placement algorithms can be configured to be aware of the maintenance domains and to make sure the affinity on MD is maintained in moving the VM from the current host to a patched host. The placement does not need to be a 1-1 placement. In some embodiments, towards the end of the MD duration, all leftover VMs will be forcefully patched and migrated to new hosts. The placement process may be used to implement load balancing to balance the loads that are placed on the nodes. In some embodiments, intelligent VM placement may be applied based upon calculation of a quantifiable metric with VM density deviation for the candidate nodes, e.g., as described in co-pending U.S. application Ser. No. __________, entitled “MAXIMIZING RESOURCE USAGE FOR DATABASE VIRTUALIZATION CLOUD PROVISIONING”, Attorney Docket Number ORC23136551-US-NPR, filed on Sep. 26, 2024, which is hereby incorporated by reference in its entirety.

In summary, embodiments of the invention perform partitioning for the maintenance period and pooling of nodes into maintenance domains, and placement of hosts within MDs adhering to constraints and goals solves the problem of maintenance requirements in complex database specialized VM clusters in the consolidated cloud infrastructure involving specialized compute and storage node

To explain in more detail, consider again the context in which embodiments of the invention may be applied, where enterprise class applications such as databases support clustered execution across independent environments for providing high availability and scalability. These execution environments can be the physical hosts or virtual machines clustered together to have one or more of these database clusters. These are specialized VM cluster environments having clustering software to bring them together and host one or more database clusters within them, such as in a heterogeneous cloud infrastructure that provides these environments as cloud service. Based on the nature of the service, this allows customers to provision these virtual machine clusters that host the specialized database clusters across them. This results in a multi-tenant environment consolidating VM clusters from various customers together in specialized infrastructure. In such cases, it is common to have VMs from different customers packed together in the same physical hosts. These hosts in the infrastructure can be of different generations over a period of time and hence the VM cluster placement can be mixed among them based on the configurations/requirements.

Even though providing compute services on cloud is common, providing a cluster computes in terms VM clusters is a challenging problem. To provide a stable and secured environment for the tenant application and services, the system should apply the critical patches through the stack in various components. Updating and hence maintaining the physical host comprising the various VMs is a critical operation that is needed to update all the hosts in the infrastructure within a specific period. There can be various different classes of patching. For example, one type of patching that may be applied is static offline patching which requires a restart of the execution entity, e.g., either the host or the VM.

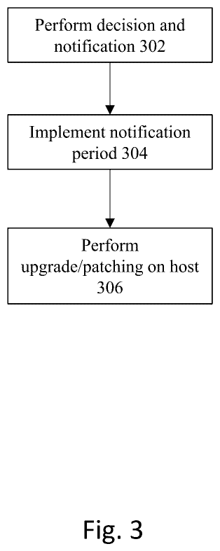

FIG. 3 shows a flowchart of an approach to use maintenance domains to implement patching/upgrades according to some embodiments. At 302, decision making and notification tasks are performed. It is at this stage that the system will determine the nodes to patch. At this point, the system will identify and reserve new nodes for a given MD that can be used to hold VMs drained from the nodes to patch in that MD.

With certain patching models, such as the offline patching model, it is generally desirable to provide users with a graceful period within which they can voluntarily migrate the VM out of the host to avoid or minimize disruption in customer services hosted within these VMs. At 304, a notification period is implemented to provide the notice to the customers. According to some embodiments, the notification period can be configured to be 2 weeks.

Thereafter, during that time period, the customer can drain its VMs from the identified node (which has been placed into a “notification state”). At this stage, the customer will reboot the VM and restart it onto another node. A set of available nodes will be placed into a free pool that can be used to hold the VMs to be drained from the identified node for upgrade. Once all the VMs are drained, at 306, the system can patch the host to bring it to required levels.

The disclosed approach can be used in a complex operational sequence involving the VM clusters that provide numerous advantages, including for example: (a) reducing any disruptions by providing the ability for the customer to span the impact of individual VMs within the VM cluster, e.g., across the notification period within the maintenance period; (b) providing the ability to sub-partition the VM cluster and place them in different notification period; and/or (c) provide a reservation of hosts which can be patched first and VMs can be migrated to the same. In some embodiments, the migration of the VMs should place them in the similar generation of hardware.

With the configuration of the current embodiments, the maintenance domains and their corresponding time intervals provide a suitable schedule that can be followed for the individual VMs, e.g., where subsequent maintenance requirement can be placed into the same window of time period in a subsequent maintenance period.

Unlike conventional solutions which can result in an unpredictable order of VM maintenance within the same VM cluster and possible disruption of complete cluster, the present approach allows for a very predictable and deterministic order of VM maintenance to be performed.

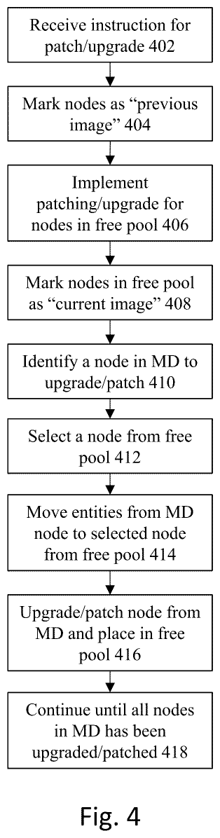

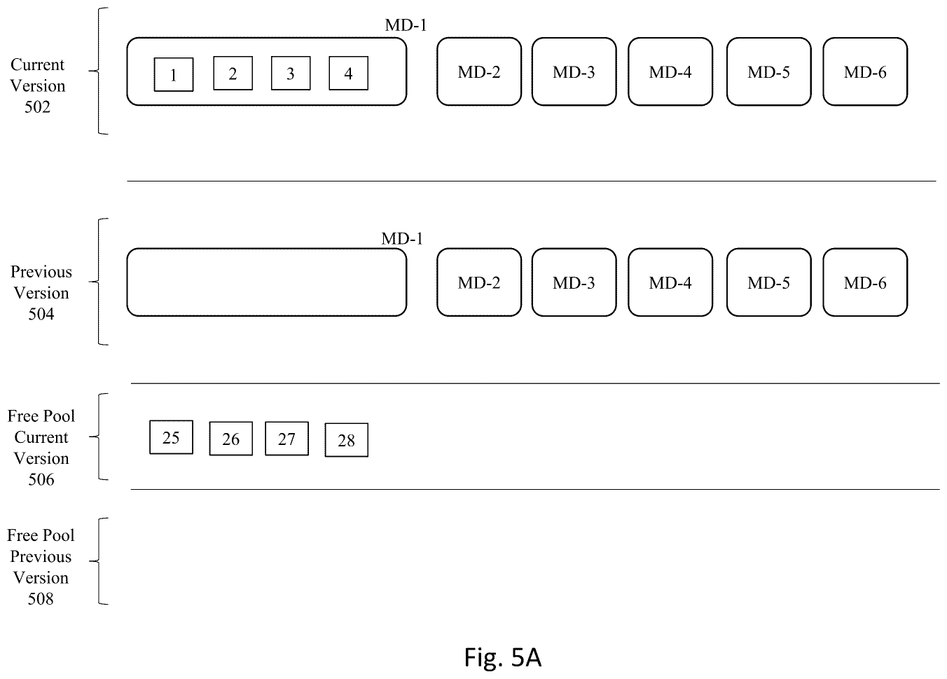

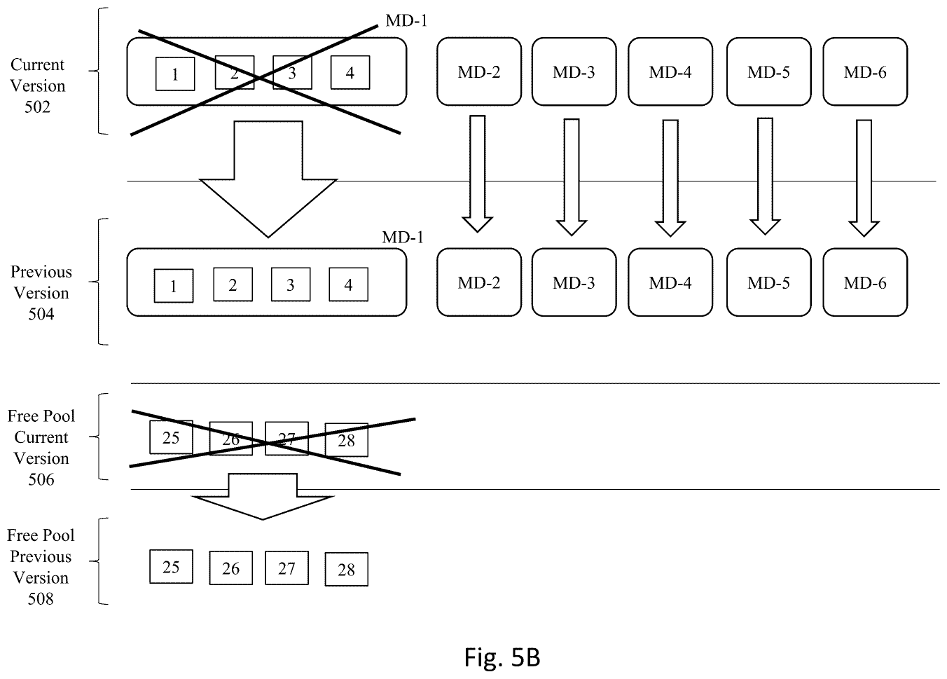

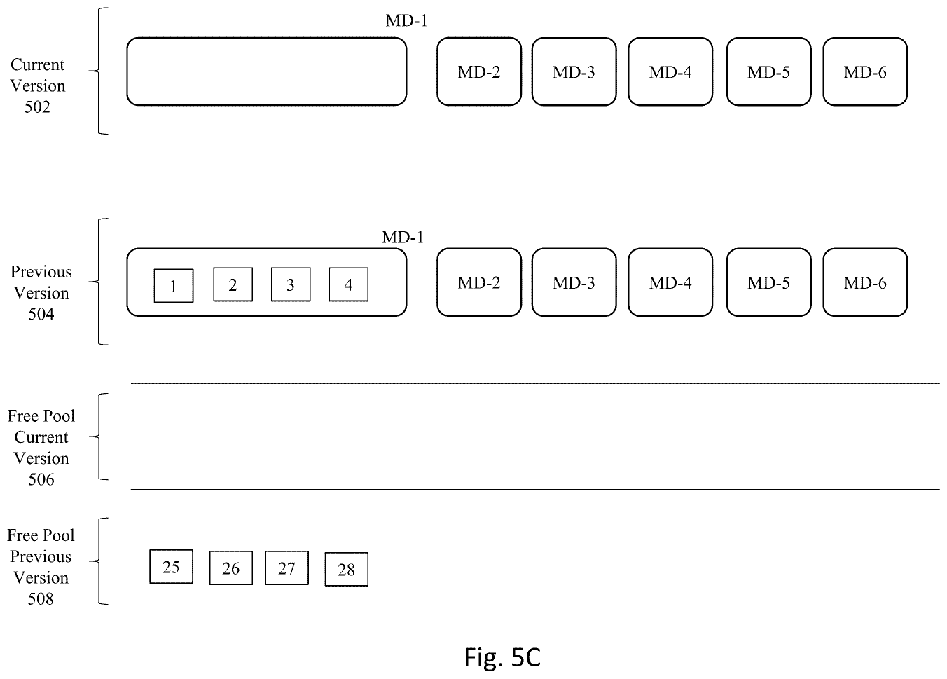

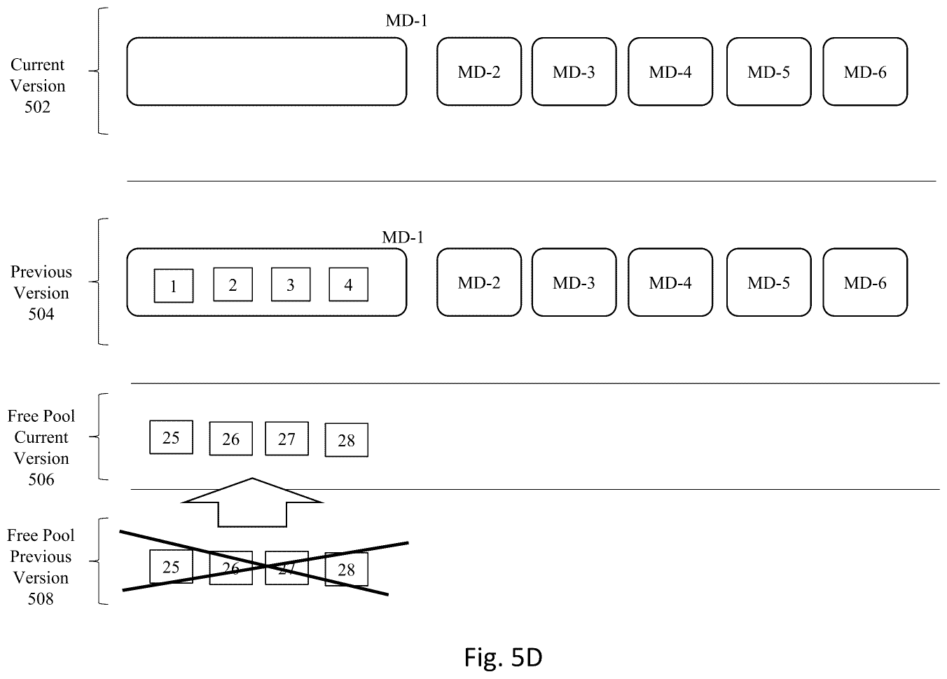

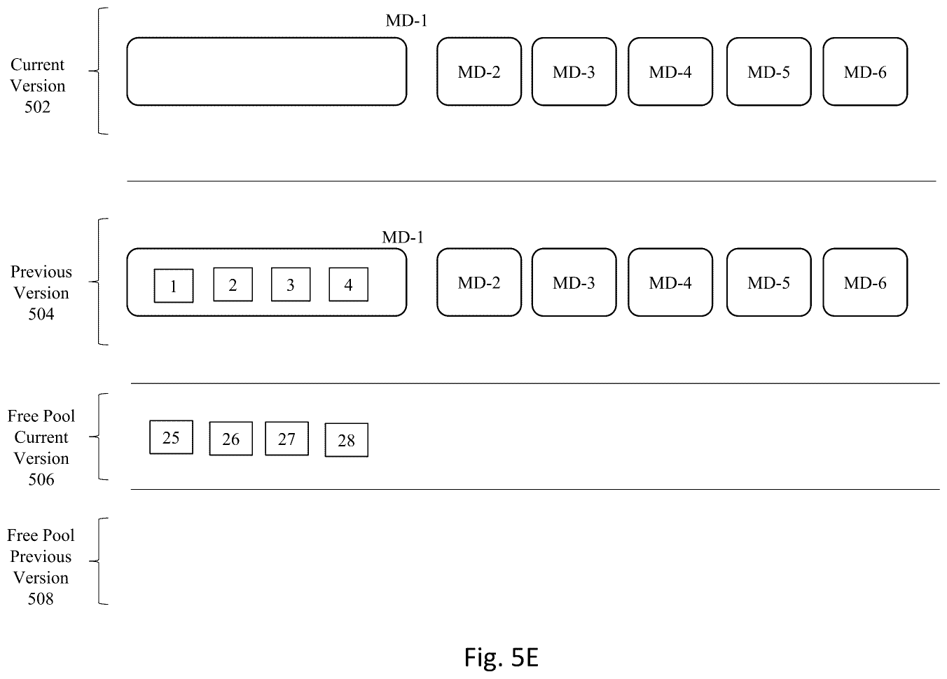

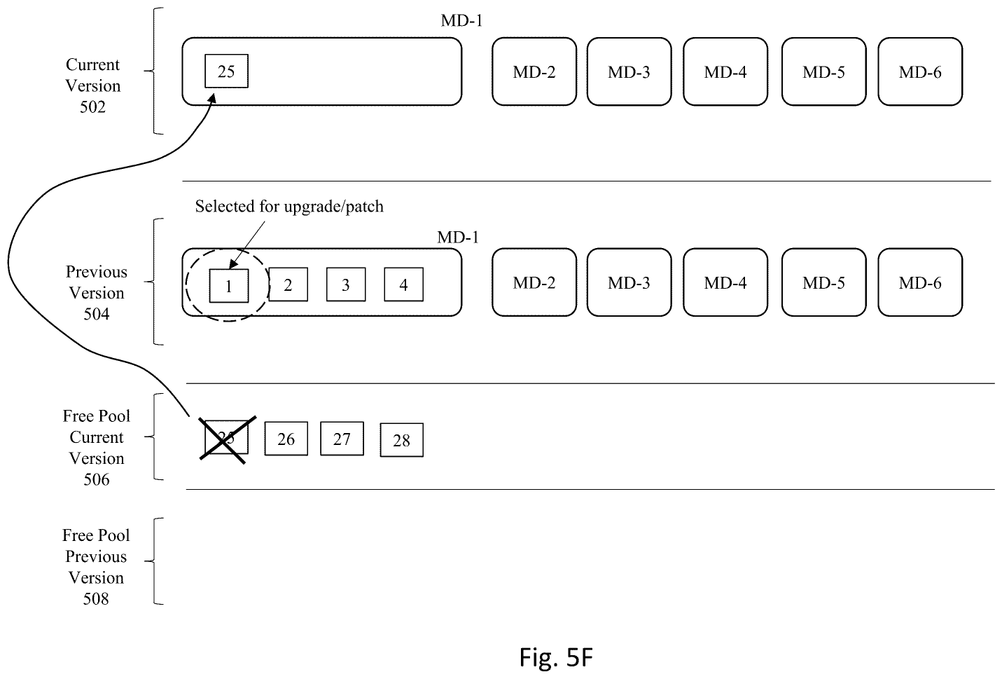

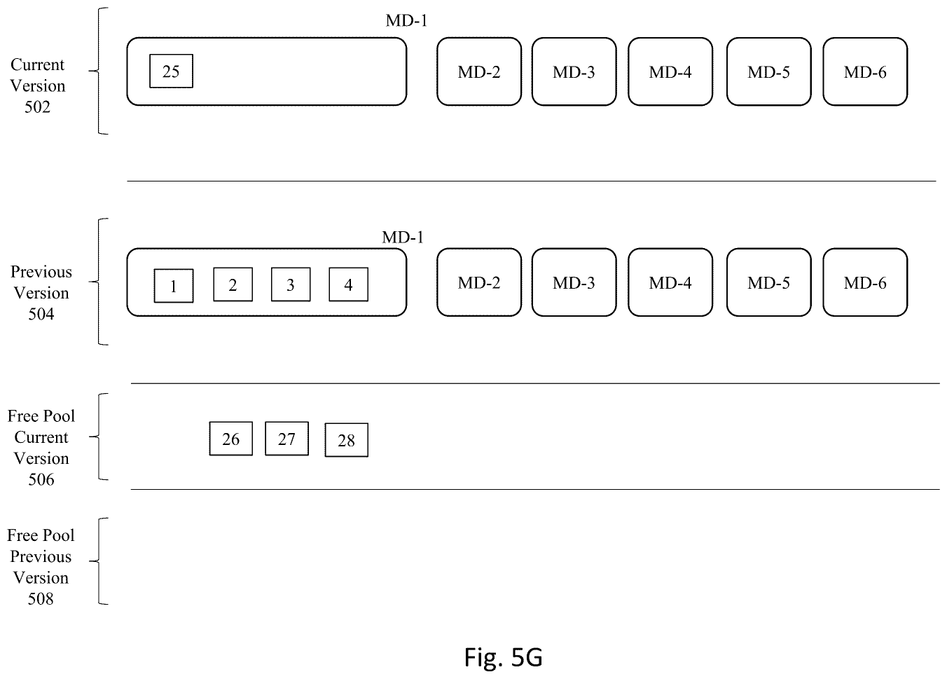

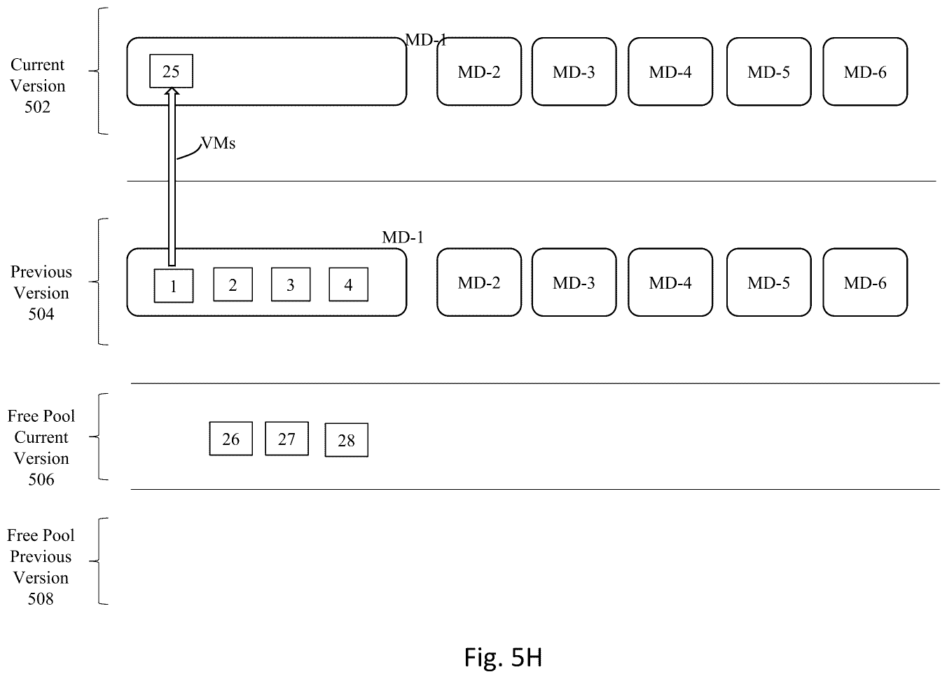

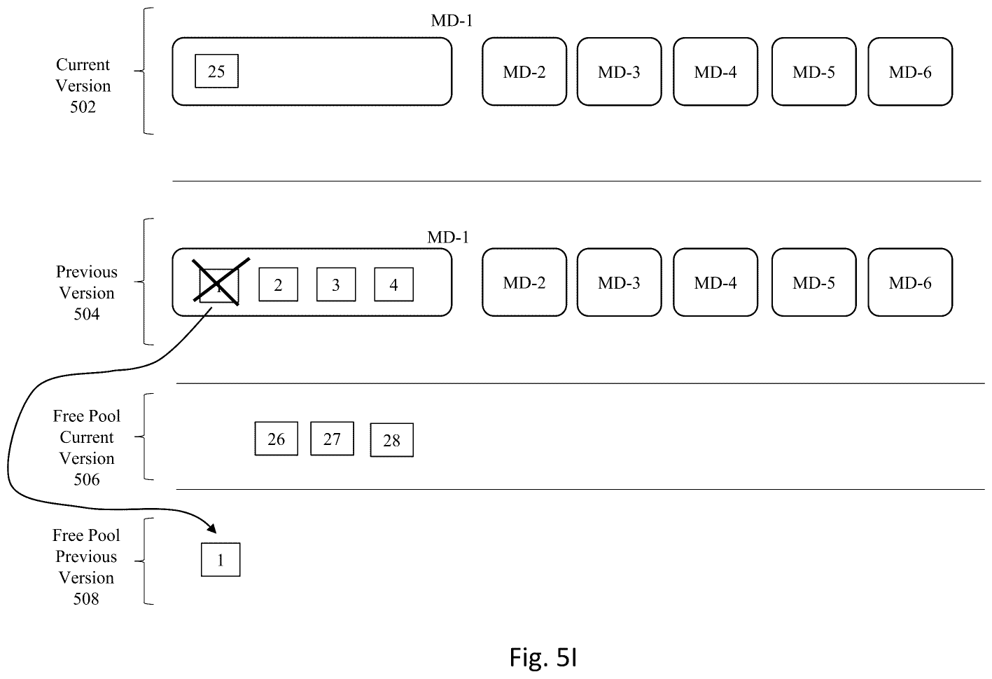

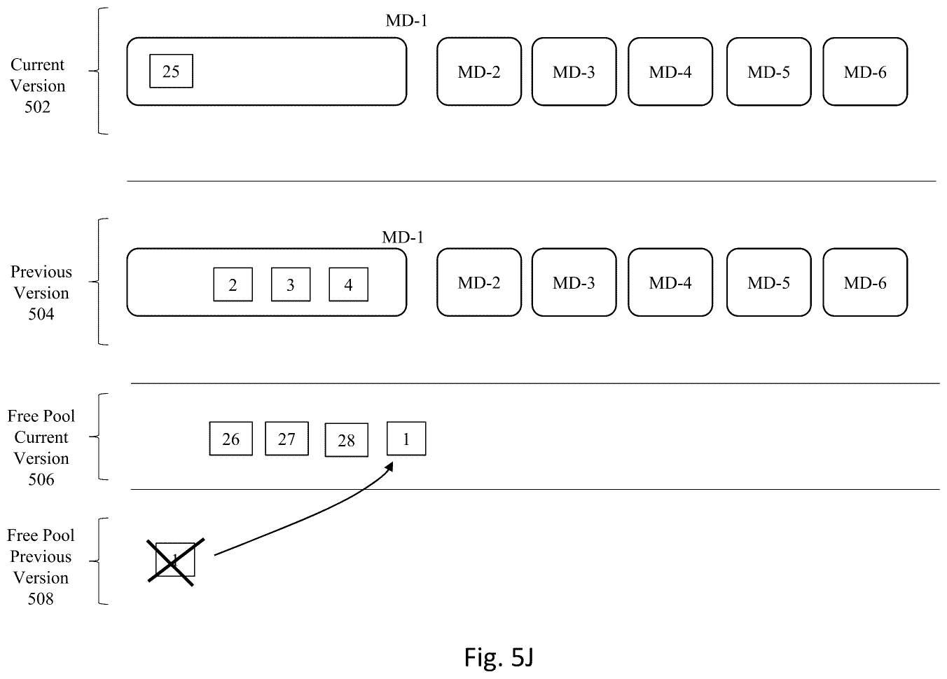

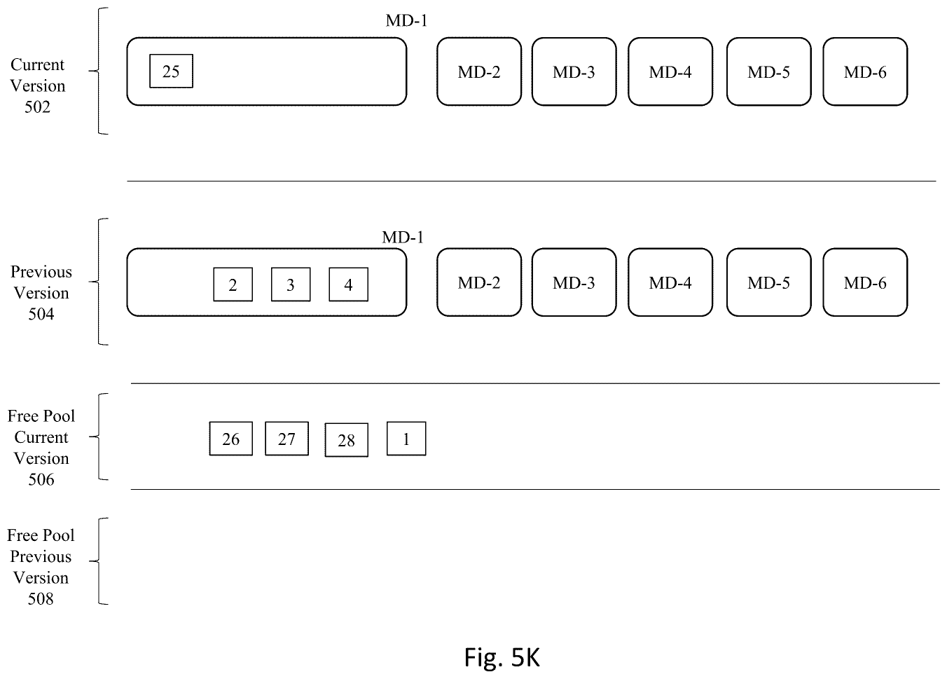

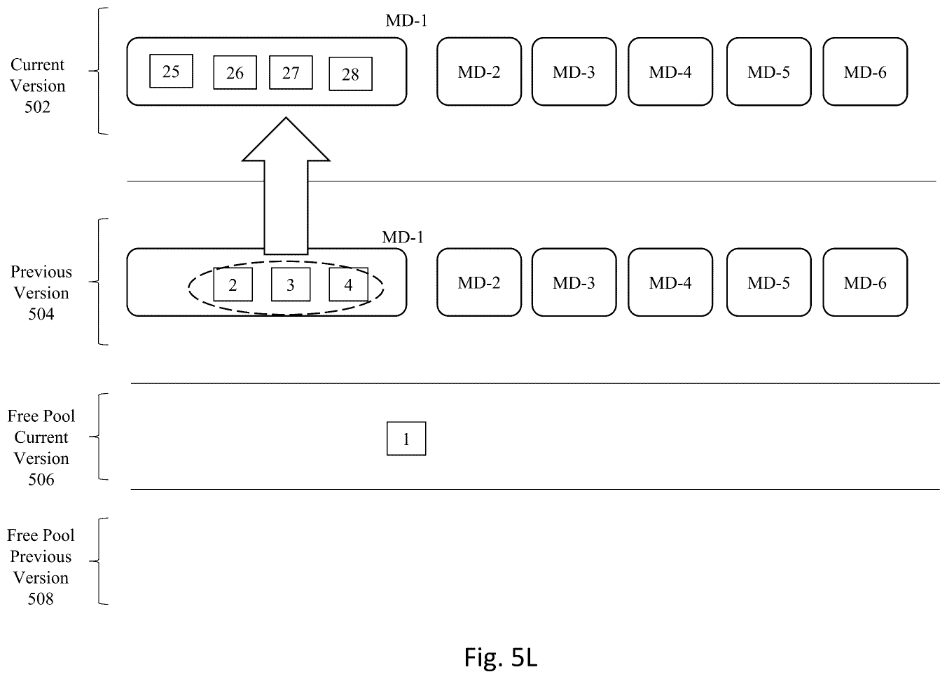

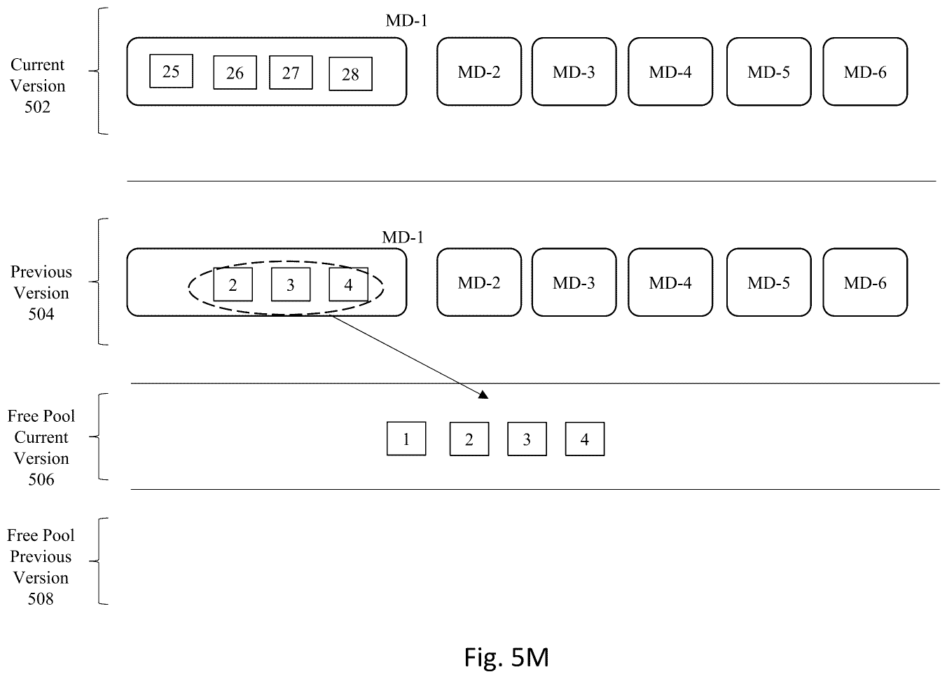

FIG. 4 shows a more detailed flowchart of actions that are performed according to some embodiments of the invention. This flowchart will be explained in the context of the illustrative example shown in FIGS. 5A-M. FIG. 5A shows a set of maintenance domains MD-1, MD-2, MD-3, MD-4, MD-5, and MD-6. Each of these maintenance domains includes any number of nodes within the domain. Here, maintenance domain MD-1 is shown to include node 1, node 2, node 3, and node 4. Each of the other maintenance domains MD-2, MD-3, MD-4, MD-5, and MD-6 may include its respective number of nodes of each domain, where perhaps nodes 5 through node 24 reside in some combination of nodes in these domains.

In addition, a set of nodes may exist in a free pool. As shown in the figure, nodes 25, 26, 27, and 28 are currently associated with the free pool. These are the nodes that are identified as being useable to hold VMs that are migrated off any node that will be undergoing an upgrade.

At the current moment in time, all the identified nodes are at the most current version of the software/configurations. As shown in the figure, nodes 1-4 within maintenance domain MD-1 are all identified as being at the “current version” 502. There are zero nodes identified as being at the previous version 504. Similarly, for the nodes 25-28 in the free pool, all of these nodes are identified as being at the current version 506. None of the nodes in the free pool are at the previous version 508.

At 402 of FIG. 4, instructions may be received to perform a patch/upgrade. What this means is that the current version of the software/configuration of the node is now out-of-date and should to be upgraded to a new version of software/configurations. Assume that the notification time period has already been provided to the users.

At this point, when an MD is processed at 404, the nodes in the MD are now marked as belonging to a previous image. Since there is a new update, this means at all nodes at the previous version are now out-of-date. Therefore, as illustrated in FIG. 5B, all of the current nodes in the MDs are now associated with the previous version 504. Specifically, this figure shows that nodes 1-4 in MD-1 now corresponds to previous version 504. In addition, the nodes 25-28 in the free pool may now also be associated with the previous version 508. The current state of these nodes is shown in FIG. 5C.

The next step is to get the nodes in the free pool ready to be useable as destinations for migrated VM from nodes in the MDs. Since the nodes in the free pool are currently at a previous version, this means that they now need to be upgraded/patched to the latest version. Therefore, at step 406, the nodes in the free pool will be placed into a “maintenance mode” and will undergo an upgrade to bring them to the current version. At 408, these nodes are now marked to be at the current version. As illustrated in FIG. 5D, this figure shows that the nodes 25-28 in the free pool have been upgraded, and now are associated with the current version 506. FIG. 5E shows the current state after the nodes in the free pool have been upgraded.

At step 410, a node in the MD currently being processed is identified for the upgrade/patch. Next, at 412, a node from the free pool is selected to process the identified node in the MD.

At this point, at 414, the virtual entities on the node in the MD can be migrated to the node that was selected from the free pool. This node from the free pool essentially becomes a new node that is now included in the MD, as a replacement for the previous node that will now need to undergo an upgrade/patch.

To explain these steps, consider the contents of FIG. 5F. Assume that node 1 in MD-1 has been selected at this point for the upgrade/patch. This figure shows that a node from the free pool (node 25) is selected to assist the process of the upgrade/patch for node 1. Since this node 25 is at the current version (as well as all other nodes in the free pool), this means that this node is ready to have additional VMs placed onto it. Therefore, node 25 is moved from the free pool and is now associated with MD-1, as shown in FIG. 5G.

FIG. 5H illustrates that the VMs that were previously on node 1 are now migrated to node 25, in preparation to perform an upgrade/patch to node 1. Once all VMs have been migrated from node 1, this node is now ready to under the upgrade/patch process.

At step 416 of FIG. 4, the empty node in the MD at the previous version is now upgraded to the latest version. At this point, the node can be placed into the free pool and made available to hold VMs for another node in the same of another MD that will need to undergo an upgrade.

FIG. 5I shows the node 1 being placed into the free pool, and associated with the previous version 508. At this point, the node 1 is placed into a maintenance mode and then undergoes a patch to the latest version. After node 1 is upgraded to the latest version, FIG. 5J now shows the node 1 in the free pool and associated with the current version 506. This is to now allow node 1 to be selected and used to help upgrade other nodes within the MDs that will need to be subsequently patched/upgraded. FIG. 5K shows the current state of the nodes at their various version levels.

Thereafter, at step 418, similar processing as described above continues until all nodes in the MD have been upgraded. As shown in FIG. 5L, the other nodes 2-4 in MD-1 are now processed, with their respective VMs moved to nodes 26-28 that were previously in the free pool. Once nodes 2-4 have been upgraded, then they will now be upgraded, moved to the free pool, and made available to be used to upgrade other nodes, as shown in FIG. 5M.

In addition, if there are any more MDS to process, then those MDs will be processes as described herein to upgrade the nodes for those MDs.

Therefore, what has been described in an improved approach to handle VM cluster maintenance through maintenance domains which partitions the interval and pool of hardware nodes, and where subsequent operations handling these concepts provide the required maintenance schedules satisfying any customer requirements. As described, this approach is well suited in the context of VM cluster maintenance and can satisfy any required availably requirements for the multi-tenant customers

### System Architecture

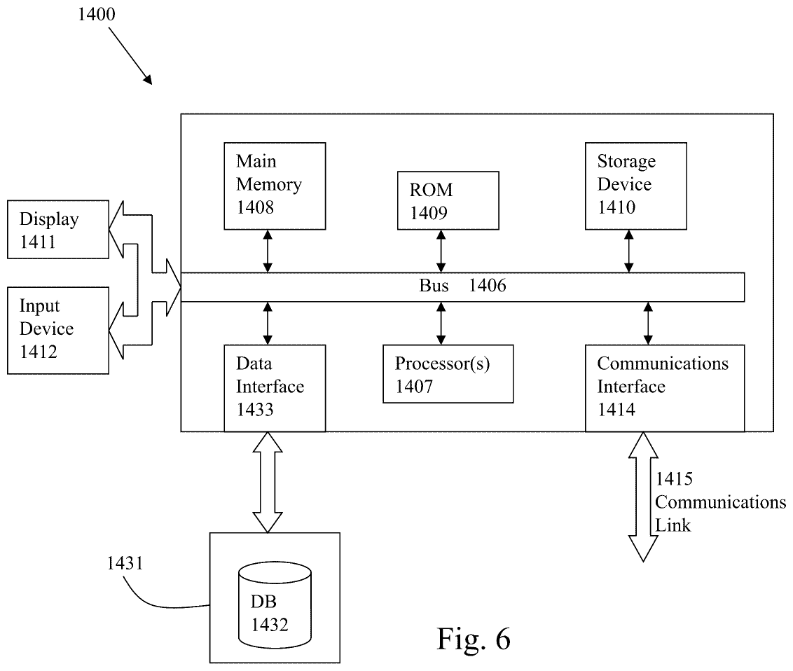

FIG. 6 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to some embodiments of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1410 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

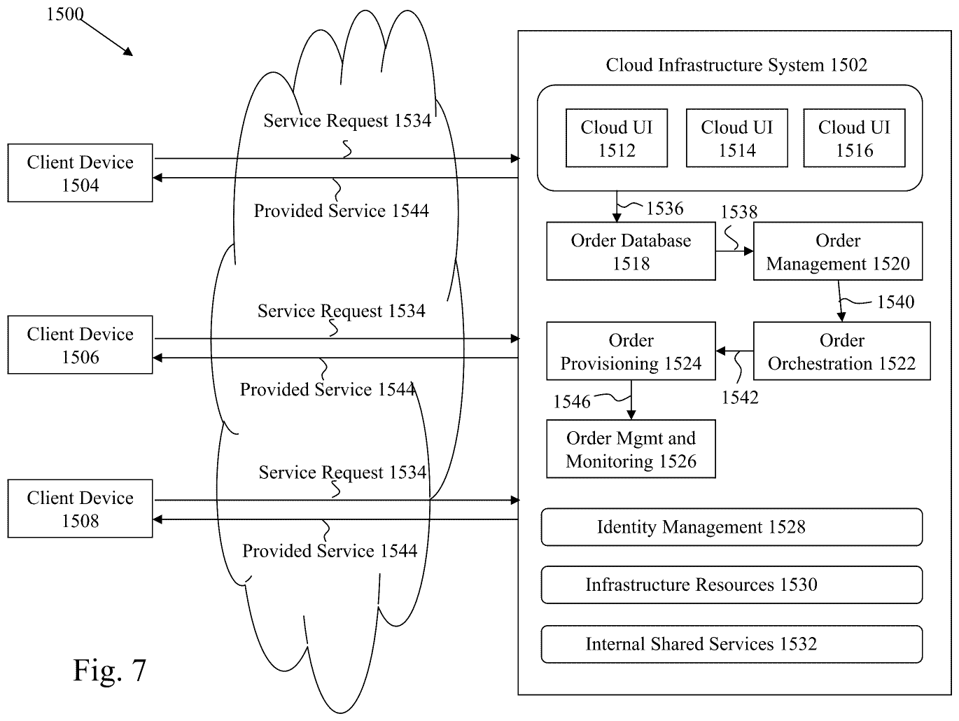

FIG. 7 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components.

Client computing devices 1504, 1506, and 1508 may be devices similar to those described above for FIG. 6. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloudservices via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloudservices may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1518 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 enables the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 enables the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method, comprising:
identifying a set of nodes used to host database virtual machine clusters;
configuring the set of nodes into a plurality of maintenance domains;
configuring a set of non-overlapping time intervals for the plurality of maintenance domains; and
performing a software update on a maintenance domain basis for the set of nodes used to host the database virtual machine clusters.

2. The method of claim 1, a set of nodes are placed into a free pool, and a first node from the free pool is selected to hold a database virtual machine that is migrated from a second node in a maintenance domain that is to be upgraded.

3. The method of claim 2, wherein after the database virtual machine is migrated from the second node in the maintenance domain that is to be upgraded, then the second node undergoes an upgrade, and afterwards is placed into the free pool to be used for the upgrade of a subsequent node.

4. The method of claim 1, wherein performing the software update on the maintenance domain basis for the set of nodes used to the host database virtual machine clusters will result in performance of load balancing for database virtual machines that are placed onto new nodes from a free pool.

5. The method of claim 1, wherein a notification time period is given to a user to provide notification for impending maintenance of nodes in a maintenance domain.

6. The method of claim 1, wherein a database virtual machine is drained from a node in a maintenance domain before the node is upgraded.

7. A computer program product embodied on a computer readable medium, the computer readable medium having stored thereon a sequence of instructions which, when executed by a processor, executes:
identifying a set of nodes used to host database virtual machine clusters;
configuring the set of nodes into a plurality of maintenance domains;
configuring a set of non-overlapping time intervals for the plurality of maintenance domains; and
performing a software update on a maintenance domain basis for the set of nodes used to host the database virtual machine clusters.

8. The computer program product of claim 7, a set of nodes are placed into a free pool, and a first node from the free pool is selected to hold a database virtual machine that is migrated from a second node in a maintenance domain that is to be upgraded.

9. The computer program product of claim 8, wherein after the database virtual machine is migrated from the second node in the maintenance domain that is to be upgraded, then the second node undergoes an upgrade, and afterwards is placed into the free pool to be used for the upgrade of a subsequent node.

10. The computer program product of claim 17, wherein performing the software update on the maintenance domain basis for the set of nodes used to the host database virtual machine clusters will result in performance of load balancing for database virtual machines that are placed onto new nodes from a free pool.

11. The computer program product of claim 7, wherein a notification time period is given to a user to provide notification for impending maintenance of nodes in a maintenance domain.

12. The computer program product of claim 7, wherein a database virtual machine is drained from a node in a maintenance domain before the node is upgraded.

13. A system, comprising:
a storage medium having stored thereon a sequence of instructions; and
one or more processors that execute the sequence of instructions to cause the one or more processors to perform a set of acts, the set of acts comprising,
identifying a set of nodes used to host database virtual machine clusters;
configuring the set of nodes into a plurality of maintenance domains;
configuring a set of non-overlapping time intervals for the plurality of maintenance domains; and
performing a software update on a maintenance domain basis for the set of nodes used to host the database virtual machine clusters.

14. The system of claim 13, a set of nodes are placed into a free pool, and a first node from the free pool is selected to hold a database virtual machine that is migrated from a second node in a maintenance domain that is to be upgraded.

15. The system of claim 14, wherein after the database virtual machine is migrated from the second node in the maintenance domain that is to be upgraded, then the second node undergoes an upgrade, and afterwards is placed into the free pool to be used for the upgrade of a subsequent node.

16. The system of claim 13, wherein performing the software update on the maintenance domain basis for the set of nodes used to the host database virtual machine clusters will result in performance of load balancing for database virtual machines that are placed onto new nodes from a free pool.

17. The system of claim 13, wherein a notification time period is given to a user to provide notification for impending maintenance of nodes in a maintenance domain.

18. The system of claim 13, wherein a database virtual machine is drained from a node in a maintenance domain before the node is upgraded.
